(19) United States
(12) Patent Application Publication
(10) Pub. No.: US 2007/0256631 A1
(43) Pub. Date: Nov. 8, 2007

(54) COATING DISTRIBUTION SYSTEM WITH INLINE INJECTION OF ADDITIVES AND METHOD OF USING THE SAME

(76) Inventors: Brad Lintner, Climax, MI (US); Constance Jo Enevold, Augusta, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/743,743

(22) Filed: May 3, 2007

Related U.S. Application Data
(60) Provisional application No. 60/797,320, filed on May 3, 2006.

(51) Int. Cl. B05C 5/00

(52) U.S. Cl. 118/24

(57) ABSTRACT

Disclosed is coating distribution system with inline injection capability that permits a base coating material to be divided into a plurality of portions, separate treatment of each portion to form a plurality of final coating compositions and recovery of the untreated base coating material. The system permits the simultaneous formation of a plurality of different final coating compositions from a single base coating material while permitting the bulk of the base coating material to remain unchanged. Using the system enables better control over the consistency of the base coating material and reduces clean up time between changes in the final coating compositions.

### RELATED APPLICATIONS

This application claims the benefit of U.S. Provisional Application No. 60/797,320, filed May 3, 2006.

### STATEMENT REGARDING FEDERALLY SPONSORED RESEARCH

None

### FIELD OF THE INVENTION

The present invention relates to a system and method for injecting additives such as colors, flavors, or nutrients into a base coating material to be applied to a food piece. More specifically, the present invention relates to a coating distribution system capable of injecting different additives such as different colors, flavors, or nutrients into a portion of the base coating material to create multiple different coating compositions thereby allowing for food pieces having different characteristics without the need to convert the entire base coating material to a single composition.

### BACKGROUND OF THE INVENTION

Systems for injecting colors, flavors, or nutrients into food streams are well known in the art. One such system is shown in U.S. Pat. No. 6,436,455 to Zietlow et al. Zietlow et al. discloses a process for making an aerated confectionery food product having multiple colors. A slurry is initially formed and divided into a plurality of food streams. Different colors are then injected into each of the food streams to form differently colored food streams. The differently colored food streams are extruded into a single rope and then cut into individual food pieces. As a result, each of the food pieces has multiple portions of different colors. Another system for injecting different colors or flavors into separate food streams and then aggregating the food streams into an individual food product having multiple portions of different colors or flavors is shown in U.S. patent application Publication No. 2005/0064087 to Richey et al.

Neither Zietlow et al., nor Richey et al., teach or suggest injecting the different colors or flavors first into a plurality of coating lines each having the same base coating and then coating a plurality of food pieces with the different coatings to form multiple food pieces having different colors or flavors. U.S. Pat. No. 4,617,872 to Melliger discloses a coating pan having multiple coating lines for distributing talc syrup, color, water, or polishing wax to the coating pan to coat pharmaceutical tablets. However, Melliger does not teach or suggest coating the pharmaceutical tablets with different coatings to form multiple tablets having different characteristics. Instead, Melliger desires to provide uniform tablets having the same characteristics.

These references disclose systems and methods for injecting or adding colors, flavors, and other coatings to a food or pharmaceutical product, but they fail to teach or suggest a system or method for injecting different additives such as different colors, flavors, or nutrients into a base coating that is to be applied to food pieces to form multiple food pieces having different characteristics. Therefore, there is a need in the art for such a system and method. The disadvantage with all of the prior art systems is that they do not make it convenient to recover unused base coating material that does not have any additives so it can be recycled through the system regardless of changes in additive additions.

### SUMMARY OF THE INVENTION

The present invention provides a coating distribution system for injecting different additives into a base coating material to be applied to food pieces. The coating distribution system comprises a use tank for holding the base coating material. A coating distribution circuit is in communication with the use tank for distributing the base coating material to a plurality of distribution points. The circuit extends from the use tank to the plurality of distribution points and from the plurality of distribution points back to the use tank for recycling unused portions of the base coating material. A heat jacket surrounds the use tank and the coating distribution circuit to maintain the base coating material at a predetermined temperature. A coating line extends from each of the distribution points. A plurality of additive containers store a plurality of different additives and an injector is disposed along each of the coating lines for injecting a different additive from the additive containers into each of the plurality of coating lines to form multiple coating materials for coating different food pieces to provide each with different characteristics.

The present invention also provides a method of distributing the coating using the coating distribution system. The method comprises the steps of holding the base coating material in the use tank, delivering the base coating material from the use tank to the plurality of distribution points, directing the base coating material from the plurality of distribution points to the plurality of coating lines, injecting different additives into each of the plurality of coating lines, and distributing unused portions of the base coating material with out any additives in the coating distribution loop from the plurality of distribution points back to the use tank.

The present invention provides the advantage of a system and method that allows the formation of multiple food pieces having different characteristics, while also minimizing change times associated with changing additives being applied to food pieces. If a single coating line were utilized to manufacturing multiple food pieces of different characteristics, the coating line would have to be shut down, cleaned, and re-assembled for use with the new additive each time a new additive is to be applied. By utilizing multiple coating lines and injecting different additives into each of the coating lines, down time can be minimized. In this instance, only an injection line extending from the additive containers to the injector would have to be replaced or flushed to inject the new additive. Thus, the entire coating line would not require shut down, cleaning, and re-assembly. In the present invention the entire batch of the base coating material is never injected with additive, therefore changes in additives can be accomplished rapidly and with minimal waste.

### BRIEF DESCRIPTION OF THE SEVERAL VIEWS OF THE DRAWINGS

Advantages of the present invention will be readily appreciated as the same becomes better understood by reference to the following detailed description when considered in connection with the accompanying drawings wherein:

FIG. 1 is a schematic view of a coating distribution system of the present invention.

### DETAILED DESCRIPTION OF THE INVENTION

Referring to the Figure, wherein like numerals indicate like or corresponding parts throughout the several views, a coating distribution system for forming multiple food pieces having different characteristics is shown generally at 10. The system 10 can be used to distribute any type of coating, but is particularly well-suited to coatings applied to food pieces in a plurality of layers in a panning process, e.g., a compound coating. The compound coating may be a chocolate coating, a yogurt coating, a syrup coating, any combination of these coatings, and the like. The present invention is not intended to be limited to the particular type of coating being applied. The food pieces being coated may include starch-molded, gelled confectionery pieces, dried fruit, gum-based pieces, and the like. The coating distribution system 10 is used to inject different additives into the base coating material to form multiple food pieces with different characteristics. The different additives may be different colors, flavors, nutrients, or any combination thereof that are added to the base coating material prior to the coating being applied to the food pieces.

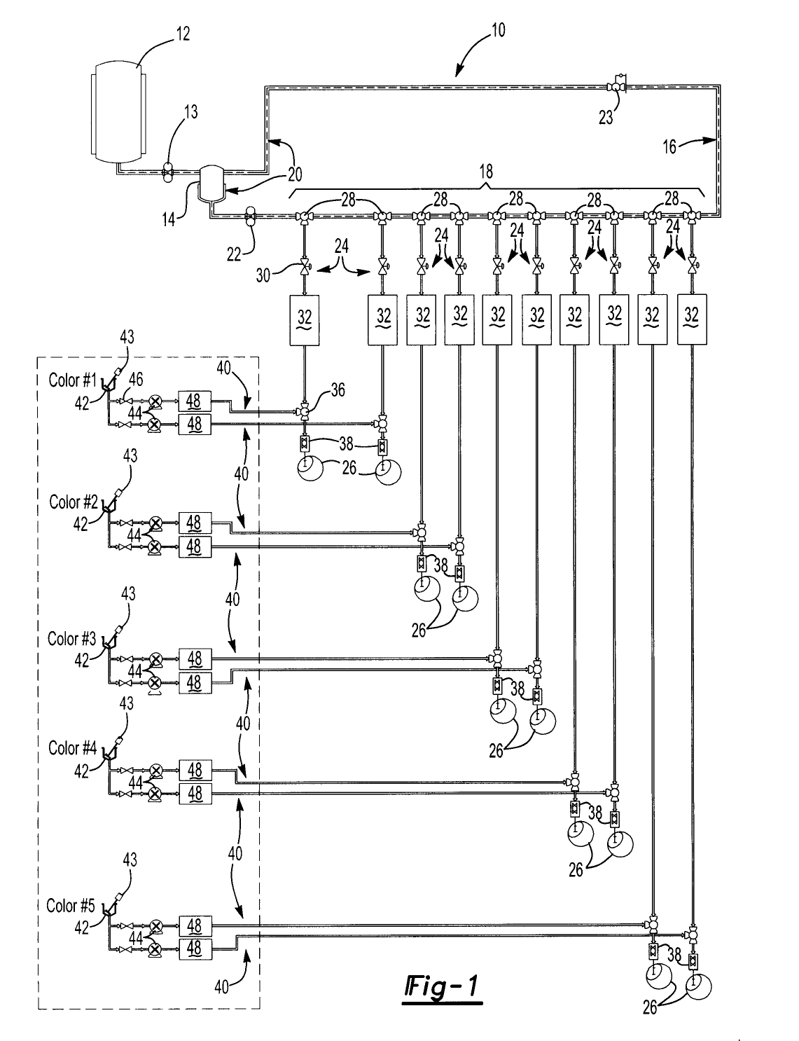

Referring to FIG. 1, the system 10 includes a bulk tank 12 for storing the base coating material. A use tank 14 receives specified quantities of the base coating material from the bulk tank 12 as needed via a pump 13. A coating distribution circuit 16 begins at a base of the use tank 14 and extends out to a plurality of distribution points 18. The circuit 16 ends back at the use tank 14 such that any unused base coating material is recycled. Water or steam jackets 20 surround both the use tank 14 and the circuit 16 to maintain the base coating material at a predetermined temperature, preferably from 98 to 140 degrees Fahrenheit, more preferably 98 to 120 degrees Fahrenheit, and most preferably 110 degrees Fahrenheit. A distribution pump 22 with a variable frequency drive (VFD) circulates the base coating material through the circuit 16. A back pressure control valve 23 may be used to control pressure in the circuit 16.

A coating line 24 extends from the circuit 16 to a coating pan 26 at each distribution point 18. Each coating line 24 includes a drain valve 28, a flow control valve 30 to control the flow rate of the base coating material in the coating line 24, a coating flow meter 32 to monitor the flow rate of the base coating material in the coating line 24 for flow control feedback, an injection point 36, and a static inline mixer 38. Only the first coating line 24 is labeled for convenience.

An injection line 40 extends from an additive container 42 to the injection point 36 to inject an additive into the coating line 24. A mixer 43 may be disposed in each container 42 to maintain homogeneity of the additive, particularly for liquid additives. Each injection line 40 includes an injector 44 (e.g., injection pump 44) to inject the additive into the coating line 24 at the injection point 36, a shutoff valve 46 to stop flow from the additive container 42, and a flow meter 48 to monitor the flow rate of the additive. Once the additive is injected at the injection point 36, the additive is mixed with the base coating material by the static inline mixer 38. The additive is actually injected through an injection port formed in the coating line 24 at the injection point 36.

In the embodiment shown in FIG. 1, the additive is a color dye such as a pre-mixed, oil-based, lake dispersion. Of course, as suggested above, the additive could be a flavor, nutrient, or any combination thereof for injecting into the coating line 24. The use of color dyes as the additive is for illustration purposes only. Continuing to use color dyes for illustration, five additive containers 42, with five different colored dyes, it is appreciated that the term color may refer to hues or variations of the same color, may be used with multiple injection lines 40 depending from each of the additive containers 42. Each additive container 42 may store a different colored dye. The additive containers 42 supply two injection lines 40 each, resulting in ten injection lines 40 routed to ten injection points 36 to ultimately yield ten coating lines of five different colors to form food pieces with coatings of five different colors.

During use, when the coating is required at the coating pan 26, the drain valve 28 will be controlled by a control unit, not shown, to automatically open and convey the base coating material to the coating pan 26. The distribution pump 22 may also be automatically controlled by a pressure-control loop to increase speed to maintain a predetermined back pressure in the circuit 16 once the drain valve 28 is opened. After the drain valve 28 is opened, the base coating material will pass through the flow control valve 30, either manually or automatically controlled, the flow meter 32, and optionally, a check valve (not shown) to the injection point 36. The injection pump 44 will then inject the additive into the coating line 24 through the injection port. In the case of dyes, the dye should be injected at 1 to 2 percent of the coating flow rate. The coating and the dye will then be mixed by the static mixer 38 and dripped onto the food pieces in the coating pan 26 at a rate estimated to be 2 to 4 lbs/minute in the case of a colored-yogurt coating added to a gelled confectionery fruit piece.

When an additive change, such as a colored dye change, is required, the dye is removed from the additive container 42 or another additive container 42 is used. The coating line 24 downstream of the injection point 36 should be flushed or if necessary disassembled, cleaned, and reassembled. In other embodiments, the old additive may simply be flushed out with a first portion of the new additive. This is particularly possible when using a compound coating applied in multiple layers. The old additive, e.g., color, may still show in the first few layers on the food product, but once the new colored dye overtakes the old, the remaining layers of the new colored dye will cover the layers with the old colored dye. This is particularly useful in panning processes where many layers are applied to a food piece. As can be seen from FIG. 1, the system 10 permits most of the base coating material to remain as base coating material thus preventing waste when there are changes in the additives added to the base coating material. Only the portion of the base coating material found after the injection point 36 has additive added to it, the rest can be recirculated in the system 10 through the circuit 16. The system permits better consistency in food formation because the same base coating material is used regardless of the additives being added. Obviously, more than 5 additives could be in the system 10 by adding more containers 42 with associated injectors 44, flow meters 48 and injection points 36.

Obviously many modifications and variations of the present invention are possible in light of the above description. While this description is directed to particular embodiments, it is understood that those skilled in the art may conceive of modifications and/or variations to the specific embodiments shown and described herein. Any such modifications or variations, which fall within the purview of this description, are intended to be included herein as well. It is understood that the description herein is intended to be illustrative only and is not intended to be limited.

What is claimed is:

1. A coating distribution system comprising:
a use tank for holding a base coating material;
a coating distribution circuit having a plurality of distribution points and extending from said use tank to said plurality of distribution points and back to said use tank;
at least one coating line extending from each of said distribution points; and
each of said coating lines in communication with at least one additive container through an injection point.

2. A coating distribution system as recited in claim 1 wherein said coating distribution circuit further comprises a distribution pump.

3. A coating distribution system as recited in claim 2 wherein said distribution pump includes a variable frequency drive.

4. A coating distribution system as recited in claim 1 wherein said plurality of distribution points comprise a plurality of valves.

5. A coating distribution system as recited in claim 1 wherein each of said coating lines further comprises a flow meter.

6. A coating distribution system as recited in claim 1 wherein each of said coating lines further comprises a mixer.

7. A coating distribution system as recited in claim 6 wherein said mixer comprises a static mixer.

8. A coating distribution system as recited in claim 1 further comprising an injector pump, said injector pump in communication with said additive container and said injection point.

9. A coating distribution system as recited in claim 1 further comprising a flow meter located between said additive container and said injection point.

10. A coating distribution system as recited in claim 1 wherein said coating distribution circuit further comprises a temperature control system.

11. A coating distribution system as recited in claim 10 wherein said temperature control system comprises a water jacketed system or a steam jacketed system, or a mixture thereof

12. A method of distributing a coating, comprising the steps of:
a) providing a base coating material in a use tank;
b) delivering a portion of the base coating material from the use tank to a plurality of distribution points along a coating distribution circuit and recirculating the remainder of the base coating material to the use tank;
c) directing a portion of the base coating material from a plurality of the distribution points to a plurality of coating lines, each of the coating lines connected to one of the distribution points; and
d) injecting at least a first additive into one of the coating lines having the base coating material to form a coating material that has a first composition that is different from the composition of the base coating material and injecting at least a second additive into another of the coating lines having the base coating material to form a coating material that has a second composition that is different from both the composition of the base coating material and from the first composition.

13. The method as recited in claim 12 wherein step b) further comprises providing a distribution pump in the coating distribution circuit to deliver the portion of the base coating material to the plurality of distribution points.

14. The method as recited in claim 13 wherein step b) further comprises providing a distribution pump having a variable frequency drive.

15. The method as recited in claim 12 further comprising the step of maintaining the base coating material at a temperature of from 98 to 140 degrees Fahrenheit in the use tank and the coating distribution circuit.

16. The method as recited in claim 12 wherein step b) comprises providing a plurality of valves as the plurality of distribution points.

17. The method as recited in claim 12 wherein step c) further comprises passing the base coating material in each of the coating lines through a flow meter on the coating line prior to step d).

18. The method as recited in claim 12 wherein step d) further comprises passing each of the first and the second additives through a different flow meter prior to injecting them into their respective coating lines.

19. The method as recited in claim 12 wherein step d) further comprises providing a mixer in each of the coating lines and the mixer mixing the base coating material with the additive in the coating line.

20. The method as recited in claim 12 comprising the further step of applying the first composition to a food piece and applying the second composition to another food piece.
